(19) United States
(12) Patent Application Publication
(10) Pub. No.: US 2011/0147600 A1
(43) Pub. Date: Jun. 23, 2011

(54) COUNTING X-RAY DETECTOR

(76) Inventor: Martin Spahn, Erlangen (DE)

(21) Appl. No.: 12/972,729

(22) Filed: Dec. 20, 2010

(30) Foreign Application Priority Data
Dec. 23, 2009 (DE) 10 2009 060 315.8

(51) Int. Cl. G01T 1/24

(52) U.S. Cl. 250/370.09

(57) ABSTRACT

For the purposes of particularly high image quality, provision is made for a counting X-ray detector for recording a digital X-ray image from X-ray radiation, with pixel readout units (14) arranged in a matrix for detecting and counting X-ray quanta (17) of the X-ray radiation, comprising a scintillator (10) for converting the X-ray radiation into photons (19) and a photocathode (11) for converting photons (19) into electrons (18), wherein each pixel readout unit (14), which has an anode (13), a discriminator (25), a counter (24) and a switching element (20), is assigned at least one gas electron multiplier (GEM) (12) for electron amplification.

### CROSS-REFERENCE TO RELATED APPLICATIONS

This application claims priority to DE Patent Application No. 10 2009 060 315.8 filed Dec. 23, 2009. The contents of which is incorporated herein by reference in its entirety.

### TECHNICAL FIELD

The invention relates to a counting X-ray detector.

### BACKGROUND

X-ray systems are used for diagnostic imaging and for interventional operations in e.g. cardiology, radiology and neurosurgery. These X-ray systems consist of e.g. at least one X-ray source and a preferably digital X-ray detector arranged on e.g. a C-arm, a high-voltage generator for generating the voltage for the X-ray source, an imaging system, a system control unit and a patient couch.

By way of example, image-amplifying camera systems based on television or CCD cameras, storage film systems with an integrated or external readout unit, systems with optical coupling of a convertor film to CCD cameras or CMOS chips, selenium-based detectors with electrostatic readout and particularly flat-panel detectors with active readout matrices with direct or indirect conversion of the X-ray radiation are known as digital X-ray detectors.

In the last-mentioned X-ray detectors, X-ray radiation is directly or indirectly converted into electrical charge, and the electrical charge is stored in so-called active matrices composed of a multiplicity of pixel readout units. The information is subsequently read out electronically, and further processed for generating an image. Typical areas of such X-ray detectors are of the order of approximately 20×20 cm² to 40×40 cm². These days, pixel sizes are usually between approximately 50 μm and 200 μm. So-called superpixels (e.g. 2×2, 3×3) can be created by binning (combining) a plurality of adjacent pixels. A distinction is made between counting and integrating X-ray detectors. In the case of a counting X-ray detector, a charge pulse in a pixel readout unit is evaluated as a signal of an X-ray quantum; by contrast an integrating X-ray detector integrates over all charge pulses in a pixel readout unit. By way of example, counting X-ray detectors are known from DE 10 212 638 A1 and DE 10 357 187 A1. The advantage of counting X-ray detectors is that the noise is almost completely suppressed and the signal-to-noise ratio can be improved. If, moreover, the single quantum is not only detected but the energy thereof is also quantified, this opens up additional options, e.g. material-specific imaging.

In general, counting X-ray detectors are based on X-ray detectors with active readout matrices with direct X-ray radiation conversion, with semiconductors such as CdTe, CdZTe, HgI, PbO, etc. being used as so-called direct convertors. Here an absorbed X-ray quantum directly generates electron-hole pairs, which are measured by an applied voltage and lead to a count result by means of suitable readout electronics.

### SUMMARY

According to various embodiments, a counting X-ray detector can be provided that generates high-quality X-ray images.

According to an embodiment, a counting X-ray detector for recording a digital X-ray image from X-ray radiation, with pixel readout units arranged in a matrix for detecting and counting X-ray quanta of the X-ray radiation, may comprise a scintillator for converting the X-ray radiation into photons and a photocathode for converting photons into electrons, wherein each pixel readout unit, which has an anode, a discriminator, a counter and a switching element, is assigned at least one gas electron multiplier for electron amplification.

According to a further embodiment, the respective gas electron multiplier can be arranged between the photocathode and the respective anode. According to a further embodiment, the gas electron multipliers can be surrounded by a drift chamber. According to a further embodiment, the X-ray detector can be embodied as a flat-panel detector. According to a further embodiment, the discriminator can be embodied as a comparator. According to a further embodiment, an optically transparent insulation layer can be arranged between the scintillator and the respective photocathode. According to a further embodiment, each pixel readout unit may have at least two gas electron multipliers. According to a further embodiment, the at least two gas electron multipliers can be arranged one behind the other in the radiation direction.

### BRIEF DESCRIPTION OF THE DRAWINGS

Various embodiments are explained in more detail in the following text with the aid of schematic illustrations in the drawings, without this restricting the invention to these exemplary embodiments. In the drawings:

FIG. 1 shows a view of an X-ray system for use in interventions according to the prior art,

FIG. 2 shows a further view of an X-ray system with a robot for use in conventional interventions,

FIG. 3 shows a view of the design of an X-ray detector according to various embodiments with one GEM layer,

FIG. 4 shows a view of the design of an X-ray detector according to various embodiments with two GEM layers,

FIG. 5 shows a top view of a GEM,

FIG. 6 shows a view of the design of a pixel readout element, and

FIG. 7 shows a further view of the design of an X-ray detector according to various embodiments with one GEM layer.

### DETAILED DESCRIPTION

The counting X-ray detector according to various embodiments for recording a digital X-ray image from X-ray radiation, with pixel readout units arranged in a matrix for detecting and counting X-ray quanta of the X-ray radiation, comprises a scintillator for converting the X-ray radiation into photons and a photocathode for converting photons into electrons, wherein each pixel readout unit, which has an anode, a discriminator, a counter and a switching element, is assigned at least one gas electron multiplier (GEM) for electron amplification. In particular, the gas electron multiplier is arranged between the photocathode and the respective anode. The so-called gas electron multiplier (GEM) was developed for particle detection in high-energy physics and is known from e.g. “Imaging with the gas electron multiplier”, Fabio Sauli, Nuclear Instruments and Methods in Physics Research A 580 (2007), page 971ff.

According to one embodiment, the gas electron multipliers are surrounded by a drift chamber, the latter extending above and below the GEM in respect of the direction of the X-ray radiation. Here the photocathode at the same time serves as a cathode for the drift chamber (adjoining in the direction of the X-ray radiation). The GEM acts as an electron amplifier by local generation of a sufficiently strong electric dipole field; thus, as a result of the amplification, a number of secondary electrons (avalanche electrons) are generated from each primary electron obtained in the photocathode. The anode-side of the drift chamber is embodied in the form of anodes with pixel-shaped structures.

Using at least one gas electron multiplier results in an indirect conversion X-ray quanta detection yield that is at least of the same order as is obtained using direct converters; however, usually it is significantly higher. Use can additionally be made of the advantages of indirect conversion or a scintillator in general. Such advantages include e.g. high X-ray absorption, short decay times, vertical structurability (the X-ray quantum is also registered at the site at which it impinges) and high radiation resistance. In indirect conversion, an X-ray quantum of the X-ray radiation generates a high-energy electron when it impinges on a scintillator, which high-energy electron in turn generates light on its path through the scintillator. The light is then converted into electrical charge below the scintillator in the pixel readout unit. The use of GEMs in conjunction with indirect conversion of X-ray quanta ensures that there are no losses when X-ray radiation is converted into an X-ray image and that almost every X-ray quantum is counted. This ensures a high image quality with exact reproduction of the examination object.

By way of example, argon and methane mixtures are used to fill the drift chamber in order to achieve drift velocities that are as high as possible. Depending on the degree of mixing, drift-field strength and pressure, this may be able to achieve drift velocities of a few cm per ps. In the case of a drift length of a few mm, this makes count rates of approximately 10⁶/s and a pixel of 100 μm or better feasible. The addition of methane to argon additionally permits a higher amplification without this leading to the permanent gas discharge. The distance between the photocathode and the anode, i.e. the height of the drift chamber, is preferably in the region of between 1 mm and 2 cm in order to be able to ensure an X-ray detector with a high yield that is as compact as possible, but it can also be selected to be greater or smaller.

The X-ray detector can be advantageously embodied as a flat-panel detector.

The discriminator can be advantageously embodied as a comparator. The use of such a comparator with one or more different thresholds allows resolving of the energy of the respectively detected X-ray quanta.

According to a further embodiment, each pixel readout unit has at least two gas electron multipliers assigned thereto. The at least two gas electron multipliers are arranged one behind the other, particularly in the radiation direction. Two GEMs connected in series can obtain an even higher amplification and thus also allow the use of scintillators with a low photon yield.

An optically transparent insulation layer is expediently arranged between the scintillator and the respective photocathode.

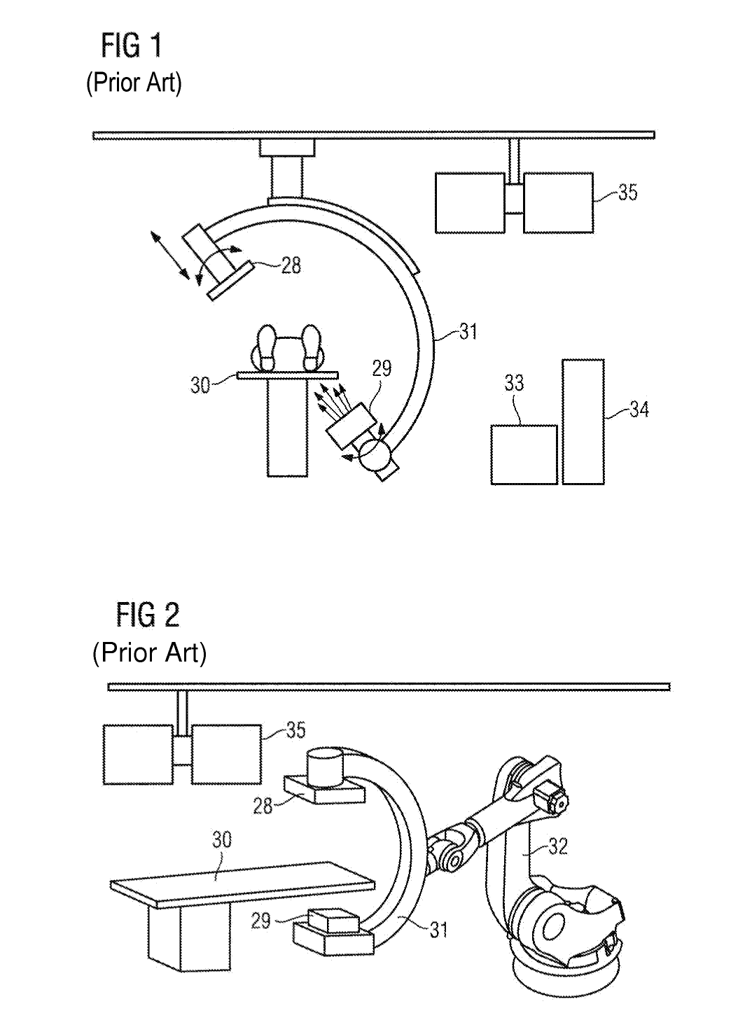

FIG. 1 and FIG. 2 show known X-ray systems, as can be used e.g. in cardiology, angiography, radiology and neurosurgery. An X-ray detector 28 and an X-ray source 29 are attached to a C-arm 31; the C-arm 31 is attached to a wall of an examination room either directly or by means of a stand (FIG. 1), or optionally by means of a multiply adjustable robotic arm (FIG. 2). The X-ray system moreover has a system control 33 with an imaging system, a generator 34, a patient couch 30 and a monitoring system 35.

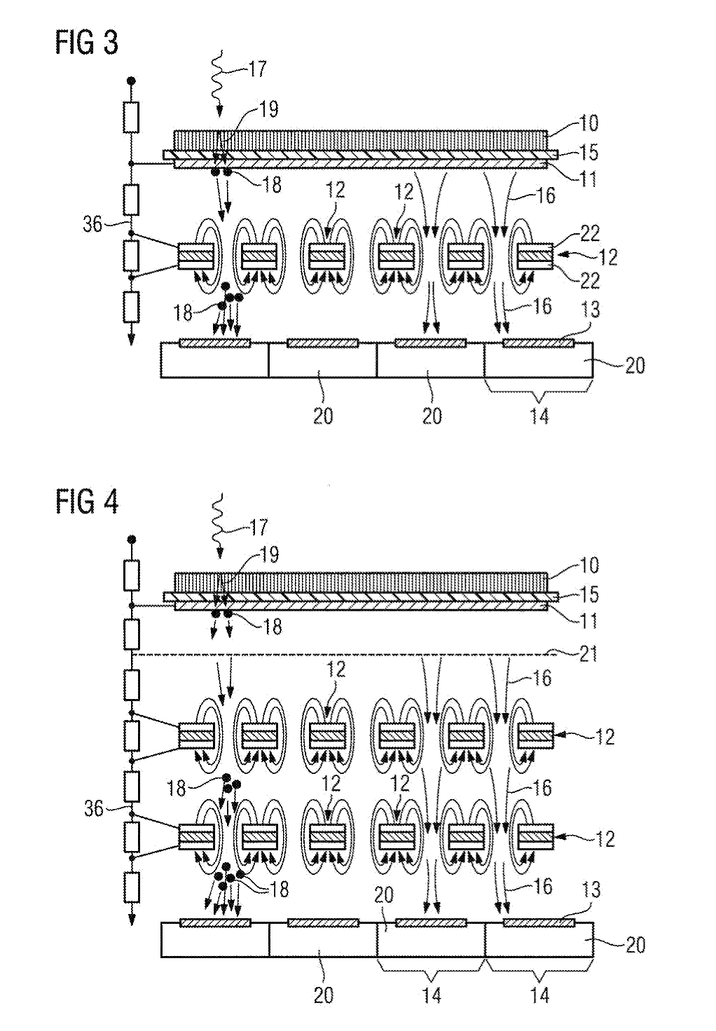

In order to obtain improved image quality, a counting X-ray detector according to various embodiments as shown in FIG. 3 is used in such X-ray systems in place of the known X-ray detector 28. The X-ray detector according to various embodiments is based on the principle of indirect conversion of X-ray quanta 17 in a scintillator 10. The optical photons 19 generated in the scintillator 10 are converted into free electrons (primary electrons) in a photocathode 11 (generally a thin metal or semiconductor layer) situated downstream thereof (in the direction of incidence of the X-ray radiation). The scintillator 10 and the photocathode 11 are electrically separated by an optically transparent insulation layer 15.

Examples of scintillators for diagnostic X-ray imaging include e.g. Gd₂O₂S or needle-shaped CsI. Other scintillators with advantageous properties such as high density (for high X-ray absorption) and short decay times of e.g. significantly under 1 μs (for high count rates) include e.g. BGO (Bi₄Ge₃O₁₂), GSO (Gd₂SiO₅:Ce) or PbWO₄; however, use may also be made of further inorganic or organic scintillators. An advantageous property of a scintillator is vertical (e.g. columnar) structuring or a configuration ensuring that light substantially generates electrons at the site (in respect of the horizontal distribution) in the photocathode where said light was absorbed. By way of example, CsI grown into a needle shape has such properties. Although CsI:Tl (which is used in many flat-panel detectors) has the disadvantage of significant afterglow and exhibits hysteresis, this can be substantially improved if a second doping element, e.g. Sm (samarium), is used in addition to Tl (thallium). Other scintillators with good temporal properties (fast decay times) and a high density include e.g. CeF₃, GSO (Gd₂SiO₅:Ce) or PbWO₄.

The X-ray detector is subdivided into pixels, wherein the scintillator 10 and photocathode 11 can have a layered design. However, further components such as anode 13 and switching elements 20 are formed in pixel readout units 14. At least one gas electron multiplier GEM 12 is associated with each pixel readout unit between the photocathode 11 and the structured anode 13, with the GEM 12 being surrounded by a drift field 16 in the direction of the photocathode 11 arranged thereover and in the direction of the anode 13 arranged thereunder. In this region, the X-ray detector is filled with a gas, e.g. a mixture of argon and methane.

The GEMs serve as electron amplifiers, with a sufficiently strong electric field being generated locally. By way of example, proportional amplifications of 10⁴ can be generated. If an even higher amplification factor is desired, one (or more) additional GEM can be connected therebehind, as shown in e.g. FIG. 4. The design of a GEM is shown in FIG. 5. By way of example, use is made of a Kapton film that is coated on both sides with a metal layer 22. Chemical etching produces holes spaced apart by 100 μm with e.g. a 50 μm diameter. As illustrated in FIG. 3 and FIG. 4, an electric dipole field is generated at the metal layers 22 at each hole of the GEM by an applied voltage from a voltage supply 36, as a result of which the amplification of an electron 18 arriving from the photocathode is achieved by means of an avalanche process.

By using GEMs (or a plurality of GEM layers), use can also be made of e.g. scintillators that have a low photon yield but entail other advantageous properties (particularly high X-ray absorption, short decay times, vertical structuring, radiation resistance).

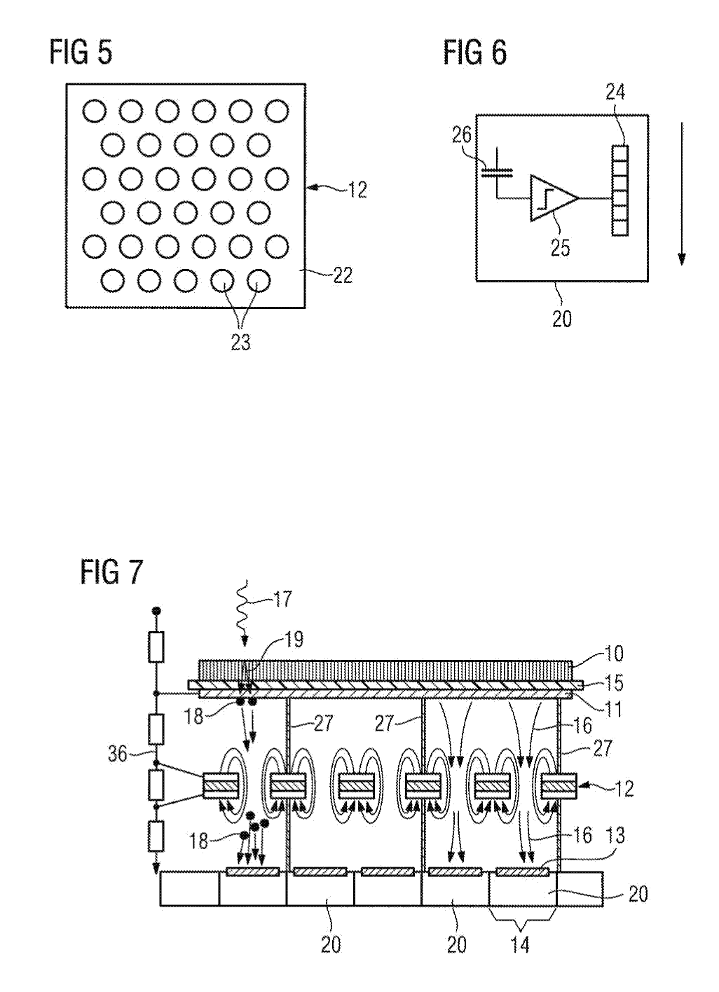

The pixel readout units 14 respectively have an anode 13, a switching element 20 that allows reading out the count rate of the pixel at given time intervals, and a counter 24 and a discriminator 25 or a comparator. FIG. 6 shows a switching element 20 with a discriminator 25, a counter 24 and a capacitor 26. By way of example, the counter 24 is increased by one after each registered event and is read out at the end of the recording.

Depending on the requirements of the application (resolution and count rate), the anodes 13 can have an area of e.g. 100×100 μm²; but they can also have a smaller or larger design. Thus, sizes of 25×25 μm², 50×50 μm² or even 200×200 μm² are feasible—depending on the requirement in respect of count rates or local resolution. In the process, the count rates of physical pixels (e.g. 50×50 μm²) can always be combined (binned) by digital means to form larger pixels (e.g. 200 x 200 pm² or e.g. 300 x 300 pm²). By way of example, the pixel readout units can be implemented by CMOS. By way of example, an alternative can be provided by an active matrix made of polycrystalline silicon (poly-Si). This can be produced in a low-energy process from amorphous silicon (a-Si:H) with the aid of crystallization by pulsed excimer lasers.

The entire region of the drift fields 16 on both sides of the GEMs can for example be embodied as a drift chamber, with a gastight housing for the X-ray detector being required for this. The drift chamber can be operated at ambient pressure in order to minimize the requirements with respect to the housing because (depending on the design) thick-walled housings may possibly have a negative influence on the absorption of the X-ray quanta. Ideally, this should only take place in the scintillator. If the drift chamber is operated at low pressure, this increases the emergence probability of the photocathode electrons. Alternatively, or in addition thereto, use can be made of an additional grid 21, as shown in FIG. 4.

Typical X-ray energies in medical diagnostic imaging are in the region of approximately 10-30 keV (mammography) and 40-120 keV (radiography, angiography). Higher energies of up to 140 keV are used e.g. in computed tomography.

The energy of the detected X-ray quantum can be resolved if a comparator with different thresholds is used instead of a simple discriminator. In the simplest embodiment this subdivides the energy into two energy ranges, e.g. above or below 70 keV in radiography. A more precise subdivision would, for example, subdivide the energy into four regions, e.g. <50 keV (but above electronic noise), 50-70 keV, 70-90 keV, and >90 keV. Further finer subdivisions are feasible, as are different energy thresholds.

In particular, the X-ray detector housing has a gastight design. The GEMs (and possibly the grid as well) are fixedly tensed in an outer frame. Alternatively, as illustrated in FIG. 7, webs 27 made of e.g. carbon or other insulating materials are arranged between the individual layers (photocathode, grid, GEM, anode) for improved stability. They ensure mechanical stability and a homogeneous drift field over the area of the X-ray detector.

In summary: for the purposes of particularly high image quality, provision is made for a counting X-ray detector for recording a digital X-ray image from X-ray radiation, with pixel readout units arranged in a matrix for detecting and counting X-ray quanta of the X-ray radiation, comprising a scintillator for converting the X-ray radiation into photons and a photocathode for converting photons into electrons, wherein each pixel readout unit, which has an anode, a discriminator, a counter and a switching element, is assigned at least one gas electron multiplier (GEM) for electron amplification.

What is claimed is:

1. A counting X-ray detector for recording a digital X-ray image from X-ray radiation, with pixel readout units arranged in a matrix for detecting and counting X-ray quanta of the X-ray radiation, comprising a scintillator for converting the X-ray radiation into photons and a photocathode for converting photons into electrons, wherein each pixel readout unit, which has an anode, a discriminator, a counter and a switching element, is assigned at least one gas electron multiplier for electron amplification.

2. The X-ray detector according to claim 1, wherein the respective gas electron multiplier is arranged between the photocathode and the respective anode.

3. The X-ray detector according to claim 1, wherein the gas electron multipliers are surrounded by a drift chamber.

4. The X-ray detector according to claim 1, which is embodied as a flat-panel detector.

5. The X-ray detector according to claim 1, wherein the discriminator is embodied as a comparator.

6. The X-ray detector according to claim 1, wherein an optically transparent insulation layer is arranged between the scintillator and the respective photocathode.

7. The X-ray detector according to claim 1, wherein each pixel readout unit has at least two gas electron multipliers.

8. The X-ray detector according to claim 7, wherein the at least two gas electron multipliers are arranged one behind the other in the radiation direction.

9. A method for recording a digital X-ray image from X-ray radiation with an X-ray detector having pixel readout units arranged in a matrix for detecting and counting X-ray quanta of the X-ray radiation, the method comprising converting X-ray radiation into photons by a scintillator and a photocathode for converting photons into electrons, assigning each pixel readout unit, which has an anode, a discriminator, a counter and a switching element, to at least one gas electron multiplier for electron amplification.

10. The method according to claim 9, further comprising:
arranging the respective gas electron multiplier between the photocathode and the respective anode.

11. The method according to claim 9, further comprising:
surrounding the gas electron multipliers by a drift chamber.

12. The method according to claim 9, wherein the X-ray detector is embodied as a flat-panel detector.

13. The method according to claim 9, wherein the discriminator is embodied as a comparator.

14. The method according to claim 9, further comprising arranging an optically transparent insulation layer between the scintillator and the respective photocathode.

15. The method according to claim 9, wherein each pixel readout unit has at least two gas electron multipliers.

16. The method according to claim 15, further comprising: arranging the at least two gas electron multipliers one behind the other in the radiation direction.

17. A counting X-ray detector for recording a digital X-ray image from X-ray radiation, with pixel readout units arranged in a matrix for detecting and counting X-ray quanta of the X-ray radiation, comprising a scintillator for converting the X-ray radiation into photons and a photocathode for converting photons into electrons, wherein each pixel readout unit, which has an anode, a discriminator, a counter and a switching element, is assigned at least one gas electron multiplier for electron amplification, wherein the respective gas electron multiplier is arranged between the photocathode and the respective anode, and wherein the gas electron multipliers are surrounded by a drift chamber.

18. The X-ray detector according to claim 17, wherein an optically transparent insulation layer is arranged between the scintillator and the respective photocathode.

19. The X-ray detector according to claim 17, wherein each pixel readout unit has at least two gas electron multipliers.

20. The X-ray detector according to claim 19, wherein the at least two gas electron multipliers are arranged one behind the other in the radiation direction.
